(19) United States
(12) Patent Application Publication
(10) Pub. No.: US 2013/0333389 A1
(43) Pub. Date: Dec. 19, 2013

(54) CROSS FIRE TUBE RETENTION SYSTEM FOR A GAS TURBINE ENGINE

(71) Applicants: Elizabeth Angelyn FADDE, Greenville, SC (US); David William CIHLAR, Greenville, SC (US); Perry Bradford SLOAN, Greenville, SC (US)

(72) Inventors: Elizabeth Angelyn FADDE, Greenville, SC (US); David William CIHLAR, Greenville, SC (US); Perry Bradford SLOAN, Greenville, SC (US)

(73) Assignee: General Electric Company, Schenectady, NY (US)

(21) Appl. No.: 13/524,335

(22) Filed: Jun. 15, 2012

(51) Int. Cl. F23R 3/22; F02C 7/00

(52) U.S. Cl. 60/752

(57) ABSTRACT

A cross fire retention system for a gas turbine engine includes a retention system housing operably coupled to a radially outer surface of a flow sleeve surrounding a combustion chamber, wherein the retention system housing includes a central aperture relatively aligned with a flow sleeve channel and is configured to receive a cross fire tube. Also included is a locking element extending through a side aperture of the retention system housing and having a first end configured to fittingly engage a first portion of an outer surface of the cross fire tube. Further included is a resilient member disposed within the retention system housing and configured to engage a second portion of the outer surface of the cross fire tube.

### BACKGROUND OF THE INVENTION

The subject matter disclosed herein relates to gas turbine engines, and more particularly to cross fire tube retention systems for gas turbine engines.

Adjacent combustors of a gas turbine engine are typically connected by cross fire tubes to ensure substantially simultaneous ignition and equalized pressure in all combustors. The cross fire tubes are secured to the combustors by various attachment assemblies and often exhibit undesirable wear at the interfaces between the cross fire tube and a liner and/or a flow sleeve of the combustors. Such wear is largely attributable to vibration levels generated from combustion dynamic pressure fluctuations, which results in costly replacement or repair of the cross fire tubes and the attachment assemblies. Additionally, interfaces of the cross fire tubes and a liner and/or flow sleeve are often of differing materials, with different thermal expansion properties. These can produce a mismatch in axial growth of cross fire tube interfaces. The various attachment assemblies often protrude into a radially interior region of the flow sleeve and/or liner, such as assemblies requiring attachment to an inner wall of the flow sleeve and/or liner. Flow path disturbances are increased due to such configurations, resulting in reduced combustor efficiency. Furthermore, requiring attachment to the inner wall of the flow sleeve and/or liner introduces cumbersome procedures associated with cross fire tube installation, removal and inspection.

### BRIEF DESCRIPTION OF THE INVENTION

According to one aspect of the invention, a cross fire retention system for a gas turbine engine includes a retention system housing operably coupled to a radially outer surface of a flow sleeve surrounding a combustion chamber, wherein the retention system housing includes a central aperture relatively aligned with a flow sleeve channel and is configured to receive a cross fire tube. Also included is a locking element extending through a side aperture of the retention system housing and having a first end configured to fittingly engage a first portion of an outer surface of the cross fire tube. Further included is a resilient member disposed within the retention system housing and configured to engage a second portion of the outer surface of the cross fire tube.

According to another aspect of the invention, a cross fire tube retention system for a gas turbine engine includes a retention system housing fixedly connected to an outer surface of a flow sleeve, wherein the retention system housing includes a central aperture configured to surround a cross fire tube having a relatively circular outer surface. Also included is a spring-loaded locking element comprising a curvilinear end configured to partially surround and engage a first portion of the relatively circular outer surface of the cross fire tube. Further included is a resilient member disposed within the retention system housing and positioned to engage a second portion of the relatively circular outer surface of the cross fire tube, wherein the resilient member is configured to allow flexible displacement of the cross fire tube upon thermal growth of the flow sleeve.

According to yet another aspect of the invention, a gas turbine engine includes a cross fire tube operably connecting a plurality of combustors, wherein the cross fire tube is removably disposed within a retention system housing that is fixedly connected to an outer surface of a flow sleeve disposed radially outward of a combustor liner. Also included is a spring-loaded locking element comprising an engagement end and a rod portion, wherein the engagement end is configured to engage a relatively circular outer surface of the cross fire tube, wherein the rod portion extends away from the engagement end and through an aperture of the retention system housing to an exterior region of the retention system housing.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is an elevational partial view of a combustor having a cross fire tube retention system operably connected thereto and having a cross fire tube disposed therein;

FIG. 2 is an enlarged cross-sectional view of the cross fire tube retention system; and

FIG. 3 is a top plan view of the cross fire tube retention system.

The detailed description explains embodiments of the invention, together with advantages and features, by way of example with reference to the drawings.

### DETAILED DESCRIPTION OF THE INVENTION

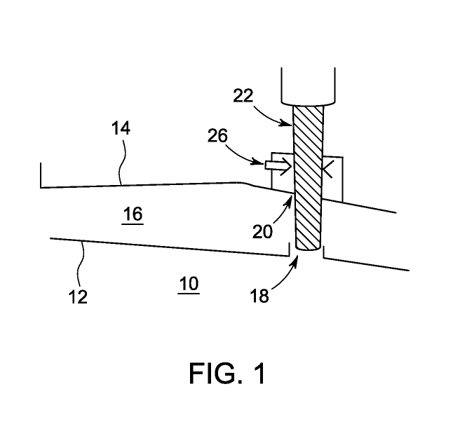

Referring to FIG. 1, a partial cross-sectional view illustrates a radially outer portion of a combustor 10 of a gas turbine engine (not illustrated). The combustor 10 is typically one of several combustors operating within the gas turbine engine, which are often circumferentially arranged in an annular array. The combustor 10 uses a combustible liquid and/or gas fuel, such as natural gas or a hydrogen rich synthetic gas, to run the gas turbine engine. An air-fuel mixture within the combustor 10 creates a hot pressurized exhaust gas. The combustor 10 is often tubular in geometry and directs the hot pressurized gas through a transition piece into a turbine section (not illustrated) of the gas turbine engine.

The combustor 10 is defined by a liner 12 which is at least partially surrounded at a radially outward location by a flow sleeve 14. An annulus 16 formed between the liner 12 and the flow sleeve 14 provides a region for an airstream to flow therein, providing a cooling effect on the liner 12. Although illustrated and previously described as having the flow sleeve 14 surrounding the liner 12, it is contemplated that only the liner 12 is present. The liner 12 and the flow sleeve 14 include a liner channel 18 and a flow sleeve channel 20, respectively, that are relatively aligned with each other. The liner channel 18 and/or the flow sleeve channel 20 are configured to receive a cross fire tube 22 therein. As illustrated, the cross fire tube 22 may simply be disposed in close proximity to the liner channel 18. The cross fire tube 22 is typically one of a telescoping assembly that is extendable and retractable. The cross fire tube 22 is in operable communication with the combustor 10 and an adjacent combustor (not illustrated) to provide for ignition of fuel in one combustor from another combustor in order to obviate the need for providing a spark plug or the like for each combustor. Furthermore, the cross fire tube 22 to some extent also effects an equalization of pressures in adjacent combustors.

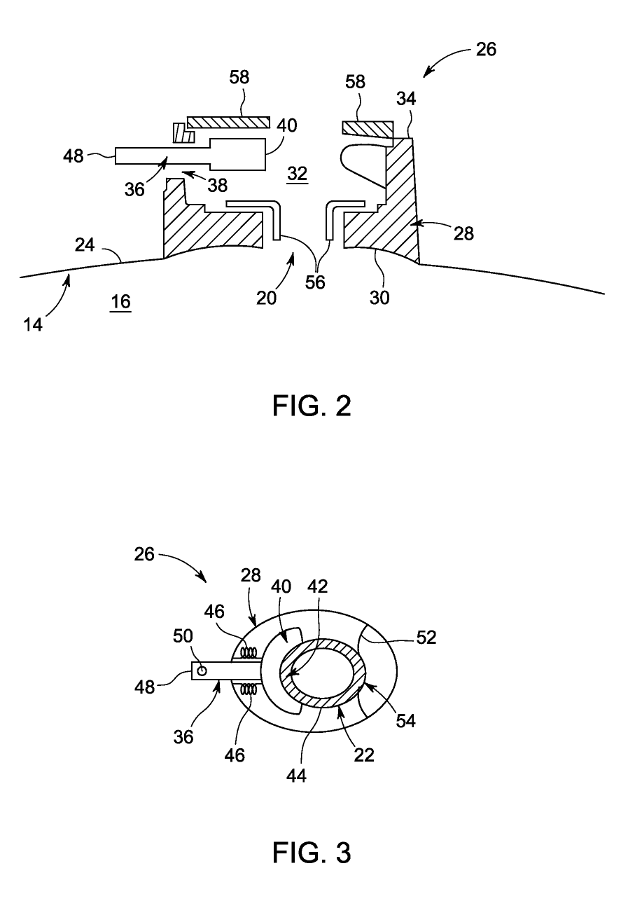

Referring now to FIGS. 2 and 3, irrespective of the precise arrangement of the cross fire tube 22 with respect to the liner 12 and the flow sleeve 14, the cross fire tube 22 is operably coupled to a flow sleeve outer surface 24 by a cross fire tube retention system 26. The cross fire tube retention system 26 includes a retention system housing 28 having a relatively concave radially inward portion 30, where the concavity corresponds to the flow sleeve outer surface 24 for mounting thereon. The retention system housing 28 may be fixedly connected to the flow sleeve outer surface 24 by any suitable fastening or joining method. The retention system housing 28 includes a central aperture 32 extending from a radially outward portion 34 of the retention system housing 28 to the relatively concave radially inward portion 30. The central aperture 32 is sized and shaped to receive the cross fire tube 22 therein and is relatively aligned with the flow sleeve channel 20 and typically the liner channel 18.

The cross fire tube retention system 26 includes a locking element 36 that is disposed within a side aperture 38 of the retention system housing 28. The locking element 36 includes a first end 40 disposed within the retention system housing 28 and configured to engage a first portion 42 of an outer surface 44 of the cross fire tube 22. Although various cross-sectional geometries are contemplated for the cross fire tube 22, the cross fire tube 22 may be of a relatively circular geometry, as illustrated. In such an embodiment, the first end 40 of the locking element 36 includes a corresponding curvilinear geometry to fittingly engage the first portion 42 of the outer surface 44 of the cross fire tube 22. At least one resilient component 46, such as an axial spring, is connected between the first end 40 and the retention system housing 28, thereby exerting a compression force on the cross fire tube 22 for retaining the cross fire tube 22 within the retention system housing 28. In order to facilitate installation and/or removal of the cross fire tube 22, a second end 48 of the locking element 36 includes a retraction facilitator 50 to provide an operator a convenient component to grip or engage during retraction of the locking element 36. The second end 48 is an elongated member that extends to an exterior region of the retention system housing 28, such that the operator has access to the second end 48 for installation or removal of the cross fire tube 22, and may be in the form of a rod or a shaft, for example. The retraction facilitator 50 may be in the form of a hole, an indentation, or a protrusion. A hole, indentation or the like provides a component that may be engaged by a hook or a similar tool, while a protrusion provides an easily gripped component to assist with overcoming the opposing force generated by the at least one resilient component 46, such as the axial spring, during retraction of the locking element 36.

The cross fire tube retention system 26 also includes a resilient member 52 disposed within the retention system housing 28 and proximate a second portion 54 of the outer surface 44 of the cross fire tube 22, which is typically about 180° from the first portion 42 of the outer surface 44 of the cross fire tube 22. The resilient member 52 may be a leaf spring, for example, although it is to be understood that various other suitable resilient members may be employed to achieve the intended purpose. During operation of the combustor 10, the hot pressurized gas therein results in thermal growth of the liner 12 and to a lesser extent the flow sleeve 14. Such thermal growth is often in the axial direction and the cross fire tube 22 is therefore prone to displacement in response to the thermal growth of the flow sleeve 14 and liner 12. In contrast to rigidly fixing the cross fire tube 22 to the flow sleeve 14, the resilient member 52 allows for axial displacement of the cross fire tube 22 during thermal growth of the flow sleeve 14. In addition to performing the retention functionality, the at least one resilient component 46 also may allow a flexible displacement of the cross fire tube 22 during thermal growth in the opposite direction.

A floating collar 56 is disposed proximate the flow sleeve channel 20 and within the retention system housing 28 to form a seal between the cross fire tube 22 and the retention system housing 28. The floating collar 56 is located below, or radially inward of, the at least one resilient component 46 and the resilient member 52. As previously described, the cross fire tube 22 may displace during thermal growth of the flow sleeve 14 and during such displacement the floating collar 56 provides an adaptable sealing component. Maintaining a seal reduces leakage into the flow path defined by the annulus 16 formed by the liner 12 and the flow sleeve 14. A cover plate 58 may be disposed above, or radially outward of, the at least one resilient component 46 and the resilient member 52 to encase the components within the retention system housing 28.

Accordingly, the cross fire tube retention system 26 is positioned on the flow sleeve outer surface 24, with a portion of the locking element 36 exposed to provide convenient installation or removal of the cross fire tube 22. Additionally, complete disposal of the cross fire tube retention system 26 on the flow sleeve outer surface 24 reduces flow disturbances within the annulus 16, while the floating collar 56 efficiently controls leakage during displacement of the cross fire tube 22.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A cross fire tube retention system for a gas turbine engine comprising:
a retention system housing operably coupled to a radially outer surface of a flow sleeve surrounding a combustion chamber, wherein the retention system housing includes a central aperture relatively aligned with a flow sleeve channel and is configured to receive a cross fire tube;
a locking element extending through a side aperture of the retention system housing and having a first end configured to fittingly engage a first portion of an outer surface of the cross fire tube; and
a resilient member disposed within the retention system housing and configured to engage a second portion of the outer surface of the cross fire tube.

2. The cross fire tube retention system of claim 1, wherein the locking element is spring-loaded to exert a compression force on the first portion of the outer surface of the cross fire tube.

3. The cross fire tube retention system of claim 1, wherein the locking element is spring-loaded, and further comprising a second end of the locking element, wherein a retraction facilitator is disposed proximate the second end to facilitate retraction of the locking element during installation or removal of the cross fire tube.

4. The cross fire tube retention system of claim 3, wherein the retraction facilitator is at least one of a hole, an indentation and a protrusion.

5. The cross fire tube retention system of claim 1, further comprising a floating collar disposed within the retention system housing and proximate the flow sleeve to at least partially form a seal between the retention system housing and the cross fire tube.

6. The cross fire tube retention system of claim 1, wherein the resilient member is a leaf spring.

7. The cross fire tube retention system of claim 1, wherein the resilient member is configured to allow flexible displacement of the cross fire tube upon thermal growth of the flow sleeve.

8. The cross fire tube retention system of claim 1, further comprising a cover plate disposed at a radially outward portion of the retention system housing.

9. The cross fire tube retention system of claim 1, wherein the retention system housing includes a relatively concave radially inward portion corresponding to the radially outer surface of the flow sleeve.

10. A cross fire tube retention system for a gas turbine engine comprising:
a retention system housing fixedly connected to an outer surface of a flow sleeve, wherein the retention system housing includes a central aperture configured to surround a cross fire tube having a relatively circular outer surface;
a spring-loaded locking element comprising a curvilinear end configured to partially surround and engage a first portion of the relatively circular outer surface of the cross fire tube; and
a resilient member disposed within the retention system housing and positioned to engage a second portion of the relatively circular outer surface of the cross fire tube, wherein the resilient member is configured to allow flexible displacement of the cross fire tube upon thermal growth of the flow sleeve.

11. The cross fire tube retention system of claim 10, wherein the spring-loaded locking element further comprises a retraction portion, wherein a retraction facilitator is disposed on the retraction portion to facilitate retraction of the spring-loaded locking element during installation or removal of the cross fire tube, wherein the retraction portion extends through a side aperture of the retention system housing to an exterior region of the retention system housing.

12. The cross fire tube retention system of claim 11, wherein the retraction facilitator is at least one of a hole, an indentation and a protrusion.

13. The cross fire tube retention system of claim 10, further comprising a floating collar disposed within the retention system housing and proximate the flow sleeve to at least partially form a seal between the retention system housing and the cross fire tube.

14. The cross fire tube retention system of claim 10, wherein the resilient member is a leaf spring.

15. The cross fire tube retention system of claim 10, further comprising a cover plate disposed at a radially outward portion of the retention system housing.

16. A gas turbine engine comprising:
a cross fire tube operably connecting a plurality of combustors, wherein the cross fire tube is removably disposed within a retention system housing that is fixedly connected to an outer surface of a flow sleeve disposed radially outward of a combustor liner; and
a spring-loaded locking element comprising an engagement end and a rod portion, wherein the engagement end is configured to engage a relatively circular outer surface of the cross fire tube, wherein the rod portion extends away from the engagement end and through an aperture of the retention system housing to an exterior region of the retention system housing.

17. The gas turbine engine of claim 16, wherein the rod portion includes a retraction facilitator to facilitate retraction of the spring-loaded locking element during installation or removal of the cross fire tube.

18. The gas turbine engine of claim 17, wherein the retraction facilitator is at least one of a hole, an indentation and a protrusion.

19. The gas turbine engine of claim 16, further comprising a resilient member disposed within the retention system housing and positioned to engage the relatively circular outer surface of the cross fire tube, wherein the resilient member is configured to allow flexible displacement of the cross fire tube upon thermal growth of the flow sleeve.

20. The gas turbine engine of claim 19, wherein the resilient member is a leaf spring.
